(19) United States
(12) Patent Application Publication
(10) Pub. No.: US 2008/0027690 A1
(43) Pub. Date: Jan. 31, 2008

(54) Hazard assessment system

(76) Inventor: Philip Watts, Long Beach, CA (US)

Correspondence Address: THE LAW OFFICE OF JOHN A. GRIECCI, 703 PIER AVE., SUITE B #657, HERMOSA BEACH, CA, 90254, US

(21) Appl. No.: 11/225,879

(22) Filed: Sep. 12, 2005

Related U.S. Application Data
(63) Continuation-in-part of application No. 11/096,709, filed on Mar. 31, 2005, now abandoned.
(60) Provisional application No. 60/558,668, filed on Mar. 31, 2004.
(60) Provisional application No. 60/608,656, filed on Sep. 10, 2004.

(51) Int. Cl. G06G 7/48

(52) U.S. Cl. 703/5

(57) ABSTRACT

A method of hazard assessment for a given geographic scenario that establishes a Hazard Assessment Model (HAM) for the geographic scenario, including a plurality of geologic models that predict events for the geologic scenario. The method establishes a set of the parameters necessary for using the geologic models to predict their respective events, wherein the parameters are defined by a combination of one or more established probabilities, established initial conditions, and established parameters defining change over time. It analyzes the HAM in time intervals over a time period, wherein at each time interval at least one of the geologic models is selected to establish an event state, and wherein each of the geologic models is selected in more than one of the time intervals, thus accumulating data on the established event states and their related parameters over the time period covered in the step of analyzing the HAM.

This application is a continuation-in-part of application Ser. No. 11/096,709, filed Mar. 31, 2005, which claims the benefit of U.S. Provisional Application No. 60/558,668, filed Mar. 31, 2004, and of U.S. Provisional Application No. 60/608,656. Each of the aforementioned applications are incorporated herein by reference for all purposes.

The present invention relates generally to an analysis assessment system, and more particularly, for a hazard assessment system for the analysis of mass transport complexes (MTCs).

The invention provides a probabilistic model to ascertain probability distributions for MTC hazards. The model reproduces deposit structures, and identifies model inputs that are most likely to produce hazardous MTCs. Typical embodiments of the present invention further reside in methods of producing and/or using assessment maps, in methods of producing and/or using Information Systems tailored for assessment, and in maps or Information Systems used for assessment. Hazard assessment is useful in numerous activities, such as hazard planning, hazard response, hazard mitigation and risk assessment.

### Introduction

A mass transport complex (MTC), which might also be known as a mass failure, landslide, flow, or the like, can present significant hazards to certain offshore structures and activities. Specifically, the integrity and operations of underwater cables, pipelines, moorings, and other marine structures, as well as onshore and near-shore structures, such as docks, loading facilities of ports and harbors, and buildings, can be threatened by MTCs. An effective and manageable use of these structures motivates a study of MTC hazards. In the context of this application, the term MTC should be construed broadly to include almost all geologic events that involve mass failure.

In general, MTC hazards are revealed by field studies of existing MTC events (Orange et al., 1999; Tappin et al., 2001, 2003; von Huene et al., 2004). Field studies are complemented by numerical models developed to evaluate MTC hazards. These include various sediment stability models (e.g., Wright and Rathje, 2003), mass transport models (e.g., Imran et al., 2001; Syvitski and Hutton, 2003; Niedoroda et al., 2003), and probabilistic models (e.g., Watts, 2003, 2004). Of these different techniques, probabilistic models have perhaps received the least attention, despite their many advantages.

Under the present invention, MTC hazards are found by combining (1) stability analyses and (2) sediment motion into a single hazards assessment model (HAM). The HAM is a probabilistic model that provides probability distributions for most MTC hazards of interest.

### Hazard Assessment Model

Geologic activity may be associated with a large number of different hazards (i.e., the possibility that a given geologic-related, and potentially dangerous, event will occur) that are based on the geologic activity affecting various bodies (e.g., ships, oil platforms, land-based vehicles and buildings, and the like). These affected bodies can be affected to different degrees, depending on the severity of the results of a hazard event. The hazard events may include above water (subarial) landslides that disturb a body of water from above the surface, underwater landslides and tsunamis. In some cases, bodies may be designed to withstand hazard events up to a certain critical level. Therefore, the probability that the critical level will be exceeded is an important criterion to consider.

The probability of such hazard events occurring can vary significantly depending on various geologic parameters, such as the sedimentation rate, the sediment strength, the water pressure, and the like. Likewise, the probability that the hazard will occur at a given level of severity (or higher) can vary substantially depending on such factors, and on the selected severity level.

Inputs for the HAM presented herein include slope morphology, sediment strength, sedimentation rate, water pressures, gas hydrate pressure and temperature, seismic parameters and other slope stability factors. The stability of any given slope may be dominated by only a few model inputs (Watts, 2004). The frequency of MTCs is controlled by the rate of occurrence of storms, earthquakes, gas hydrate phase change, oversteepening, sedimentation events and other MTC triggering mechanisms. The HAM performs two distinct computations. Stability analyses of sediment structures evaluate MTC failure planes. Sediment motion post failure describes MTC velocities and deposition.

Several differences between the earlier work (Watts, 2003, 2004) and the HAM are of particular importance. First, HAM computations are carried out explicitly on a periodic basis (e.g., a yearly basis), directly providing return periods of practical interest. Second, HAM outputs can preferably occur at any distance from the initiation of mass failure. Third, HAM outputs can preferably provide information on landslide hazards and/or tsunami hazards. Fourth, slope stability is preferably treated by a method of slices with a variety of failure plane shapes (Turner and Schuster, 1996). Fifth, gas hydrates can influence slope stability in the HAM.

### Uses for Uncertainty

The slope conditions that trigger hazardous MTCs are found by running the HAM multiple times with randomized inputs. The HAM uses probability distribution functions to address geological uncertainty, with the understanding that these uncertainties may have a greater impact on sediment deposits than the errors in the slope stability or sediment motion models used. This idea is further demonstrated below.

Random model inputs are provided to address geological uncertainty. The HAM also addresses epistemic uncertainty, or the differences among experts. Epistemic uncertainty is inherent to the current state of expert knowledge, which is distinct from geological uncertainty. Epistemic errors can be ascertained by running several different models and comparing the simulation results. This approach has been adopted by Syvitski and Hutton (2003) among others.

At every physical location in the HAM, probability distribution functions describe the sediment velocities attained and the sediment distances traveled. The probable structure of MTC deposits is formed over time. The following discussion reports an example that reproduces known deposits, showing the usefulness of the HAM to inform risk analyses for offshore structures.

### Offshore Santa Barbara Results

We undertook a case study to compare seismic images of layered MTCs with results found by running the HAM. The chosen slope is off Santa Barbara, Calif.

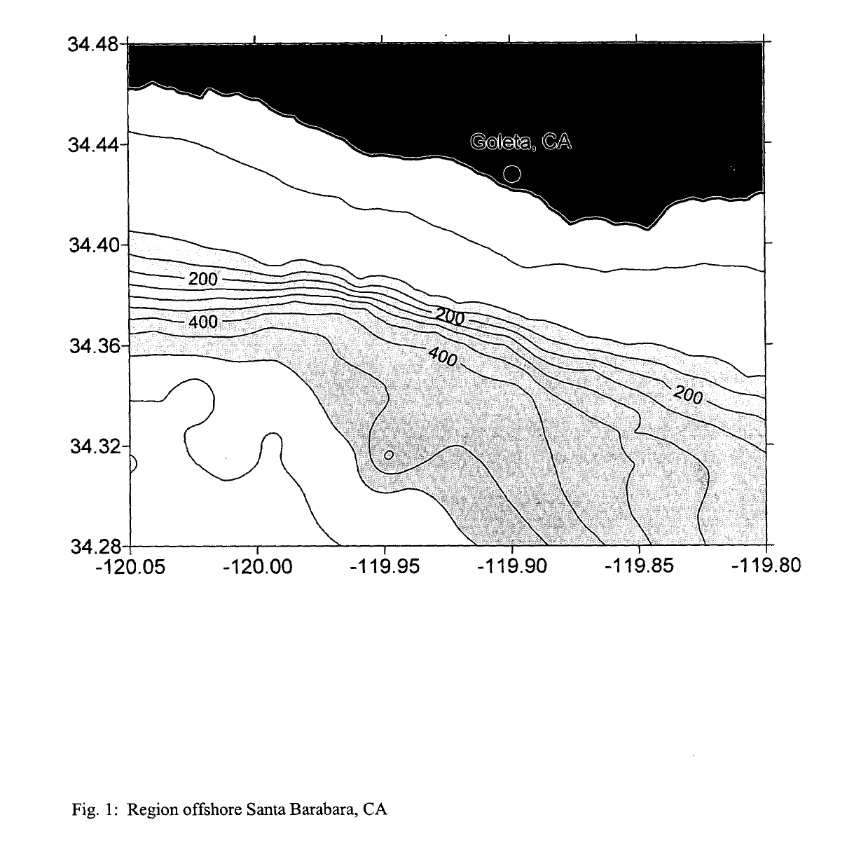

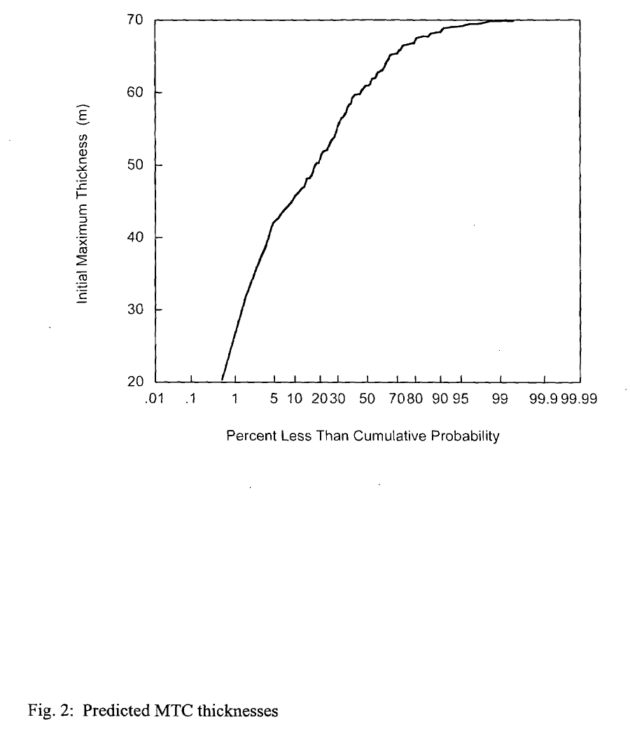

(FIG. 1). The probability of an earthquake of a given magnitude is provided by the Working Group on California Earthquake Probabilities (1995). We ran the HAM for 169,000 years and produced 95 MTC events, for a mean return period of every 1800 years. With a typical sedimentation rate of 4 mm per year, we can expect 7 m of sediment between each MTC event. The computed thicknesses in

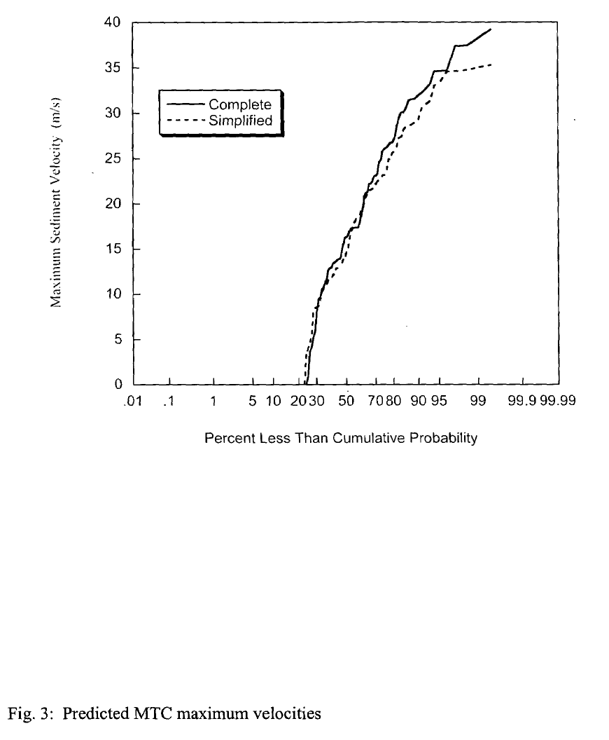

FIG. 2 indicate that MTCs favor a typical thickness of around 60 m in these sediments and on this slope. These values agree qualitatively with the recent work of Lee et al. (2003) and Greene et al. (2003). We estimate maximum sediment velocity using analytical models in this work for demonstrative purposes. We predict the maximum sediment velocity using a “complete” model given by Watts (1998) and a “simplified” model given by Watts et al. (2003). We find that 24% of MTC events undergo creeping motion. While the two probability distributions appear very similar,

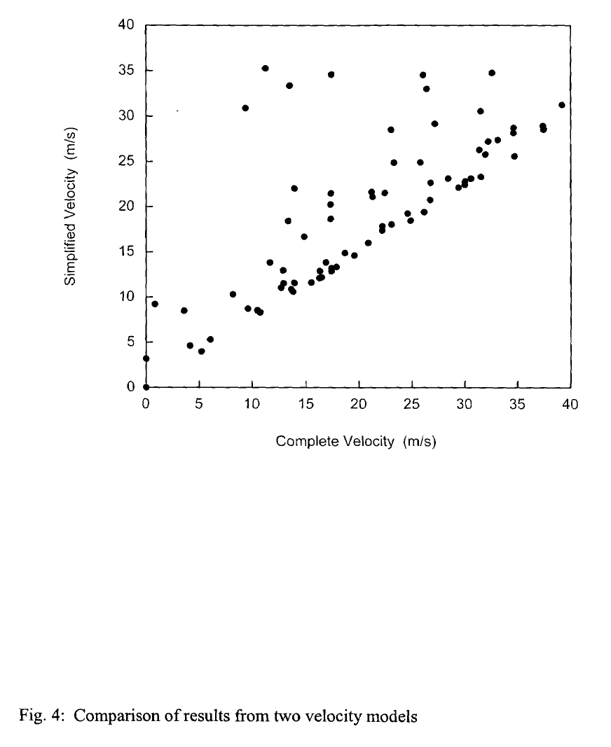

FIG. 4 shows that the correlation between the two velocity models is not favorable. We predict the maximum sediment runout using a “complete” model given by Watts and Waythomas (2003) and a “simplified” model given by Walder et al. (2003).

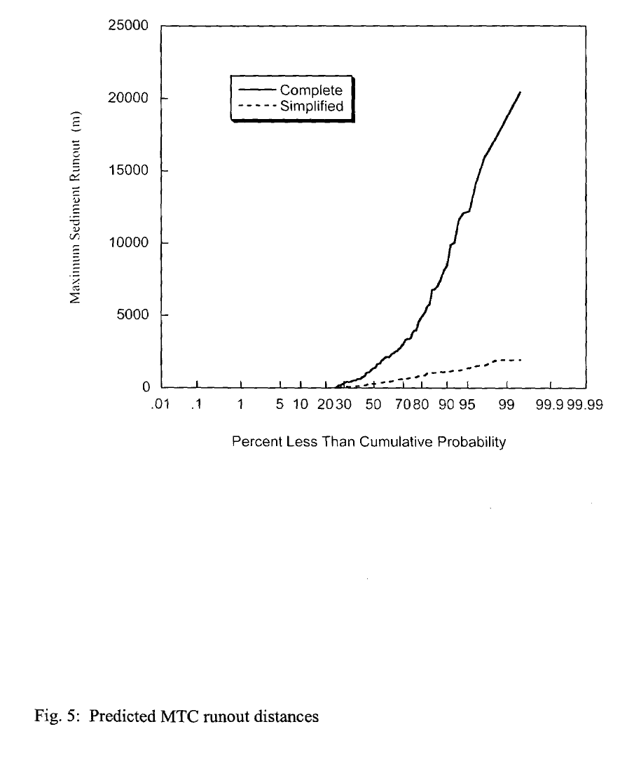

FIG. 5 demonstrates the significant difference in results from the two models.

### DISCUSSION OF SANTA BARBARA RESULTS

We compared HAM results with known deposits off Santa Barbara documented by recent marine surveys (Lee et al., 2003; Greene et al., 2003). The HAM results appear to be able to predict the deposit structure with reasonable accuracy. We did not find any significant difference in the probability distributions as a function of the stability analysis method used, which is apparently a common result (Turner and Schuster, 1996; Syvitski and Hutton, 2003). We also found that sediment center of mass motion is robust to different analytical models (Watts and Grilli, 2003). However, sediment runout appears to depend significantly on the chosen model. This means that some MTC structures are poorly constrained by existing models. Consequently, a random choice of model inputs and a random choice of models may be the only way to ascertain the realm of possible MTC hazards.

### Conclusions from Santa Barbara Results

A probabilistic model can describe the probability distributions of MTC hazards.

Existing deposits appear to validate the HAM to the degree possible. The HAM reproduces deposit structures, and identifies model inputs that are most likely to produce hazardous MTCs.

### References

Greene, H. G., Fisher, M. A., Normark, W. R., and Maher, N. (2003). “Dating one slide event of the complex compound Goleta submarine landslide, Santa Barbara Basin, Calif., USA.” Abstract, AGU Fall Meeting.

Imran, J., Parker, G., Locat, J., and Lee, H. J. (2001). “1D numerical model of muddy subaqueous and subaerial debris flow,” J. Hyd. Eng., ASCE, Vol 127, No 11, pp 959-968.

Lee, H. J., Normark, W. R., Fisher, M. A., Greene, H. G., Edwards, B. D., and Locat, J. (2003). “Ages of potentially tsunamigenic landslides in Southern California.” Abstract, AGU Fall Meeting.

Niedoroda, A. W., Reed, C. W., Hatchett, L., and Das, H. S. (2003). “Developing engineering design criteria for mass gravity flows in deep ocean and continental slope environments.” Submarine Mass Movements and Their Consequences, J. Locat and J. Mienert (Eds.), Kluwer Academic Publishers, Dordrecht, 85-94.

Orange, D. L., Greene, G. H., Reed, D., Martin, J. B., Ryan, W. B. F., Maher, N., Stakes, D., and Barry, J. (1999). “Widespread fluid expulsion on a translational continental margin: Mud volcanoes, fault zones, headless canyons, and organic-rich substrate in Monterey Bay, California.” Bull. Geol. Soc. Am., 111, 992-1009.

Syvitski, J. P. M., and Hutton, E. W. H. (2003). “Failure of marine deposits and their redistribution by sediment gravity flows.” PAGEOPH, 160, 2053-2069.

Tappin, D. R., Watts, P., McMurtry, G. M., Lafoy, Y., and Matsumoto, T. (2001). “The Sissano, Papua New Guinea Tsunami of July 1998—Offshore Evidence on the Source Mechanism.” Marine Geology, 175, 1-23.

Tappin, D. R., Watts, P., and Matsumoto, T. (2003). “Architecture and failure mechanism of the offshore slump responsible for the 1998 Papua New Guinea tsunami.” Submarine Mass Movements and Their Consequences, J. Locat and J. Mienert (Eds.), Kluwer Academic Publishers, Dordrecht, 383-389.

Turner, A. K., and Schuster, R. L. (1996). Landslides: Investigation and mitigation. Special Report 247, Trans. Res. Board, National Academy Press, Washington, D.C. von Huene, R., Ranero, C. R., and Watts, P. (2004). “Tsunamigenic slope failure along the Middle America Trench in two tectonic settings.” Marine Geology, 203, 303-317.

Walder, J. S., Watts, P., Sorensen, O. E., and Janssen, K. (2003). “Water waves generated by subaerial mass flows.” J. Geophys. Res., 108(B5), 2236-2255, doi:10.1029/2030 2001JB000707.

Watts, P. (1998). “Wavemaker curves for tsunamis generated by underwater landslides.” J. Wtrwy, Port, Coast, and Oc. Engrg., ASCE, 124(3), 127-137.

Watts, P. (2003). “Probabilistic analyses of landslide tsunami hazards.” Submarine Mass Movements and Their Consequences, J. Locat and J. Mienert (Eds.), Kluwer Academic Publishers, Dordrecht, 163-170.

Watts, P., and Grilli, S. T. (2003). “Underwater landslide shape, motion, deformation, and tsunami generation.” Proc. of the 13th Offshore and Polar Engrg. Conf:, ISOPE03, Honolulu, Hawaii, 3, 364-371.

Watts, P., Grilli, S. T., Kirby, J. T., Fryer, G. J., and Tappin, D. R. (2003). “Landslide tsunami case studies using a Boussinesq model and a fully nonlinear tsunami generation model.” Nat. Hazards and Earth Sci. Systems, EGU, 3(5), 391-402.

Watts, P., and Waythomas, C. F. (2003). “Theoretical analysis of tsunami generation by pyroclastic flows.” J. Geoph. Res., 108(B12), 2563-2584.

Watts, P. (2004). “Probabilistic Predictions of Landslide Tsunamis off Southern California.” Marine Geology, 203, 281-301.

Working Group on California Earthquake Probabilities (1995). Seismic hazards in Southern California: Probable earthquakes, 1994 to 2024. Bull. Seis. Soc. Am., 85(2), 379-439.

Wright, S. G., and Rathje, E. M. (2003). “Triggering mechanisms of slope instability and their relationship to earthquakes and tsunamis.” PAGEOPH, 160, 1865-1877.

### DETAILED DESCRIPTION

The invention may be understood by referring to the following description. This description of particular preferred embodiments of the invention, set out below to enable one to build and use particular implementations of the invention, is not intended to limit the invention, but rather, it is intended to provide particular examples of it.

Typical embodiments of the present invention reside in an assessment system for hazard assessment, that is, in methods of assessment, in methods of producing and/or using assessment maps, in methods of producing and/or using Geographic Information Systems tailored for assessment, and in maps or Information Systems used for hazard assessment for mass transport complexes, tsunamis, and the like. Hazard assessment is useful in numerous activities, such as hazard planning, hazard response, hazard mitigation and risk assessment.

### I) Selection of Models, Weightings, Initial Conditions, an Interval and a Time Period Model Selection

A method embodying the invention will employ a Hazard Assessment Model (HAM) including a plurality of models that predict events for a particular geologic area. Depending on the type of information to be studied, such models might typically include sediment stability models (e.g., Wright and Rathje, 2003), mass transport models (e.g., Imran et al., 2001; Syvitski and Hutton, 2003; Niedoroda et al., 2003), tsunami models, and the like. A step in conducting the method of this embodiment will include selecting a set of models to be used in the HAM, and preferably selecting a weighting of the likelihood of use of each model (i.e., a Bayesian weighting of the models) if relevant information or opinions are available on a preferred weighting.

### Establishment of Parameters

Typically, the selected models will establish an inherent set of parameters necessary for using the models to predict their respective events. A further step in conducting the method of this embodiment will include establishing a means of providing such parameters. For example, the parameters might include events that occur in random magnitudes over great lengths of time, such as sedimentation, or the receding of glaciers. The parameters might also include events that will or will not occur with a random likelihood. The parameters could also include simple time-dependant events. In this step of the embodiment-method, each such parameter might therefore be characterized as having one or more associated probabilities of occurrence (e.g., the likelihood of the occurrence of an earthquake, or of various weather phenomena), or statistical magnitudes (e.g., the mean and variance of the size of a sediment deposit), or as having additional parameters that define the parameter's value (e.g., the likelihood that an earthquake might occur could be considered to be based in part on the amount that a glacier has receded, and the level of the tide might be considered to depend on the date and time, or on the position of celestial bodies).

In any such case, each such parameter is characterized by criteria that may be modeled in a Monte Carlo analysis (i.e., a statistical evaluation of mathematical functions using random samples, as is known in the statistical arts). Optionally, each selected criterion could include alternative variations for use in different runs of the HAM thus providing for a confidence level analysis based on that criterion. For example, a parameter that has a value of 5+/− a random number from −1 to 1, could have variations of: 3+/− a random number from −1 to 1, and 7+/− a random number from −1 to 1.

For time dependent criteria (such as sedimentation level, over-consolidation, sediment stresses, and the like), reasonable initial conditions are also selected, typically based on either known present day or past conditions. Alternative variations of the initial conditions could optionally be selected for different runs of the HAM, thus providing a confidence level for the appropriateness of the initial conditions.

In some cases, models may be preferably selected or not selected based on their applicability of their events or the availability of information on their parameters. More generally, including a wide variety of models may be preferable, even those that might appear to be less appropriate based on the limited availability of information prior to an analysis using the HAM. Optionally, the selection of models could include alternative sets of models for use in different runs of the HAM, thus providing for a confidence level analysis based on the selection of models.

As noted above, a model weight may be selected for each model. The model weight is used to determine the likelihood that a given model is used at a particular time. Model weights may be selected from various criteria, such as the acceptance of the model in professional circles, the applicability of the model for the given geography, the model's past performance in representing known events, or the model's apparent suitability based on prior HAM analyses. Optionally, each selection of model weight could include alternative variations for use in different runs of the HAM, thus providing for a confidence level analysis based on model weighting.

### HAM Term and Interval

With the selected set of models and model weights, preferably including model subsets such as a set of one or more sediment stability models and a selected set of one or more mass transport models (and possibly one or more tsunami models), and with a set of established parameters necessary for using the set of models, another step is a selection of an appropriate time step or interval (a “HAM interval”) to pass between the times at which analyses are made using the models. More particularly, a HAM interval should be chosen small enough that periodic changes in the various established parameters can be modeled in the HAM.

Optionally, the selection of HAM interval could include alternative HAM intervals for use in different runs of the HAM, thus providing for a confidence level analysis based on the HAM interval.

In an additional step of the method of this embodiment, a HAM term (i.e., a time period over which the HAM analysis is run at each HAM interval) is selected. Preferably the HAM term is set to a value that provides for the analysis to extend through many HAM intervals. A preferred number of HAM intervals will depend on the period of the cycles and/or probabilities of the parameters, the length of the HAM intervals, the number of models in the selected set of models and its subsets, and the model weighting. The HAM term should be set at a level providing enough HAM intervals to sample the full probability space of potential events modeled. Optionally, the selection of HAM term could include alternative HAM terms for use in different runs of the HAM, thus providing for a confidence level analysis based on the HAM term. Preferred confidence levels will generally be had from longer HAM terms and shorter HAM intervals.

### II) Recursively Running the Models of the HAM in a Given Scenario

For the particular geologic area, and given a scenario, e.g., the selected set of models and model weights, the set of established parameters necessary for using the set of models, the criteria (including initial conditions) that characterize the parameters, and the selected HAM interval and term, the method of this embodiment includes steps under which the analysis may proceed. The steps of the method recited in the following paragraphs of this section constitute a single run of the HAM, i.e., a HAM run.

More particularly, at a given initial time, software routines conduct a model analysis of the geographic region using the selected models. For example, in the model analysis of the above-described models, and under control of the routines, a model is randomly selected from the set of one or more sediment stability models. Each probabilistic parameter is assigned a random outcome value based on its probability criteria, and the other parameters are given an outcome value based on their initial conditions and any related probabilistic criteria. In a first variation of this embodiment, not all of the parameters are assigned a value, but instead only those required for the selected model are assigned a value. In a second variation of this embodiment, the parameters assigned values include all that are required by the selected model, and all that are time dependent.

The selected sediment stability model is then run using the parameters. If the outcome is found stable, the time is incremented by the HAM interval, and the process of selecting a sediment stability model and calculating parameter values is restarted at that new time. Optionally, a record may be kept of the analysis conducted, including the model used and the parameter values at that time step.

If instead the outcome is found not to be stable, a record is made of the stability analysis at this time step, preferably including the time step, the type of sediment stability model, the relevant parameters, and the resulting stability data. Then in a recursive step, a mass transport model is randomly selected from the set of one or more mass transport models. Additional parameter values are calculated for the selected mass transport model, if need be. The mass transport model is run to produce characteristic data for the landslide modeled by the selected mass transport model. A record is then made of the time step, the mass transport analysis at this time step, preferably including the type of mass transport model, the relevant parameters, and the resulting landslide data.

If the HAM includes tsunami modeling, and if the results of the mass transport modeling produce data indicating that a tsunami might occur, the data from the first two models at this time steps are used in a third, tsunami model. More particularly, in another recursive step, a tsunami model is randomly selected from the set of one or more tsunami models. Additional parameter values are calculated for the selected tsunami model, if need be. The tsunami model is run to produce characteristic data for the potential tsunami modeled by the selected tsunami model. A record is then made of the tsunami analysis at this time step, preferably including the time step, the type of tsunami model used at this time step, the relevant parameters, and the resulting tsunami data.

It should be understood that, depending on the types of modeling in use, this recursive process can proceed at some depth for each time step, with each model potentially spawning recursive modeling steps for potential events that can be modeled. For example, one could use models where earthquakes affect the probability of a landslide, and landslides change the layers of sediment and thereby change the probability of an earthquake. In such a case, the model might recursively model earthquakes and landslides until one does not occur. In other words, models can trigger other models, just as geological events can trigger other geological events.

As noted above, a result of the HAM run of a given scenario will generally produce raw data files that may include data on various events occurring at various times of the HAM term. This data for each event might include landslide velocity, landslide momentum, landslide thickness, deposit thickness, wave amplitude, and the like, all distributed spatially.

### III) Alternative Variation Scenarios and Scenario Repetitions

The method of this embodiment preferably includes the steps of running additional runs of the HAM for the particular geologic area, using alternative variation scenarios. These other runs are typically made using the alternative variations discussed above, e.g., alternative variations of the set of models or model weights, alternative variations of the parameter criteria (which include initial conditions), and/or alternative variations of the HAM intervals and/or terms. Alternatively, or additionally, the additional HAM runs may duplicate previously run scenarios (i.e., scenario repetitions), but with different sets of random numbers used to generate the parameters throughout the runs. The initiation and oversight of these runs can be under the direct control of a person directing the HAM analysis, or can be under the control of an automated HAM system controller.

Similar to the initial run, the runs of the alternative variation scenarios and scenario repetitions will generally produce raw data files that may include data on various events occurring at various times of the HAM term of each scenario. This data for each event of each scenario might include landslide velocity, landslide momentum, landslide thickness, deposit thickness, wave amplitude, and the like, all distributed spatially.

### IV) Parametric Analysis of the HAM Results

The method of this embodiment preferably further includes the step of analyzing the raw data of the one or more completed HAM runs. This analysis will typically be done by analysis software, which may be under the direct control of a person directing the HAM analysis, or under the control of an automated HAM system controller. As noted above, the raw data for any one event recorded throughout the HAM term of that in of information resulting from the analysis of any one HAM run may include landslide velocity, landslide momentum, landslide thickness, deposit thickness, wave amplitude, and the like, all distributed spatially.

### Analysis of a Given HAM Run

For each analyzed HAM run, a statistical analysis may be conducted to determine a variety of statistical data for that scenario. More particularly, for each analyzed HAM run, quantities such as landslide velocity, landslide momentum, landslide thickness, deposit thickness, wave amplitude, and the like, may be analyzed to produce statistical data such as the mean, median, standard deviation, likelihood of occurrence, confidence level of it happening within a given time period (e.g., 100 years), average length of time until a first event exceeding a threshold level, and the like. These statistical data may be evaluated spatially over the geographic area of the analysis.

Furthermore, for each analyzed HAM run, these statistical data may be parametrically evaluated in light of the many available parameters that vary throughout the HAM term of the scenario. For example, for any given geographic location within the analyzed region of a given HAM scenario, the likelihood of occurrence of a marine landslide can be parametrically analyzed over the range of sediment stresses that occurred during the HAM term. Likewise, the magnitude of a tsunami resulting from a landslide triggered by an earthquake can be parametrically analyzed over the range of earthquake magnitudes and over the range of sediment levels that occurred during the HAM term. The results of these analyses will be multidimensional arrays of data, each providing a dependant variable (e.g., the likelihood of occurrence or the tsunami magnitude) against the various relevant independent variables (e.g., geographic latitude and longitude within the geographic area, sediment stress level, earthquake magnitude and/or sediment level).

### Analysis Across Multiple HAM Runs

If data are available for multiple HAM runs that cover alternative variation scenarios, then parametric analyses preferably also are run on across the variations between the scenarios. For example, if a given statistical parameter (e.g., likelihood of an earthquake of magnitude 3.5 or greater) is set at different alternatives (e.g., 2%, 4%, 6%) in different runs of the HAM, then a parametric analysis is preferably run on various effects of interest (e.g., the likelihood of a 30′ or greater tsunami), providing a geographically dependent sensitivity of the effect of interest to the given statistical parameter.

If data are available for scenario repetitions, then the above-described statistical analyses and parametric analyses are preferably compared and verified for the repeated scenario. If these analysis results vary, it may be indicative of flaws in the scenario, such as an insufficient HAM term or an excessive HAM interval. Notably, the compared results may be geographically dependent, providing for a decision maker (or an automated, rule-based, system controller) to determine if the results are adequate in the geographic areas of greatest importance.

For further accuracy on the selection of HAM term and interval, alternative variation HAM terms and/or intervals may be run (as described above), providing geographically dependent sensitivity data to the selected level of HAM term and interval. Thus, the step of analyzing the raw data may include validation steps for the HAM term and interval. These validation steps preferably establish confidence levels (preferably being geographically dependent) for the HAM term and interval. The step of analyzing the raw data may also include validation steps for other scenario parameters, with associated confidence levels that may also be geographically dependent.

A complete HAM scenario analysis may be analyzed at the completion of all intended runs, or multiple HAM scenario analyses may be made upon completion of various numbers of HAM runs. In the later case, the analyses may provide information used in determining the number and type of additional HAM scenarios that should be run.

More particularly, the step of analyzing the raw data can be used to initiate repetitions of the step of running additional runs of the HAM. The initiation decision could come from a director of the HAM analysis, or from an automated, rule-based, system controller. Examples of rules that could initiate further runs would include the following criteria: results where the HAM term or interval proved to be inadequate in a validation step, as described above; results showing extreme sensitivity to a parameter that is not easily well determined in real life; unexpected sensitivity results from the analysis of a parameter that was only minimally varied; and the like. Of course, with enough runs of the HAM, the parametric analysis may provide sensitivity information for each model, model weighting, parameter, criteria, and covered event.

### V) Presentation of the Results

### Resulting Data

As alluded to above, a wide variety of data may be obtained from one or more HAM runs. For example, for any given HAM run, landslide velocities, landslide momentum, landslide thicknesses, deposit thicknesses, wave amplitudes, and the like can be obtained. Also, for any given HAM run, probabilistic outputs, such as mean, or median event magnitudes or likelihoods, standard deviations (or variations) of event outcomes, likelihood of events, skewness, confidence levels of events happening within a given time period (e.g., 100 years), all distributed spatially, can be obtained. For multiple HAM runs, comparisons between HAM results that can produce measures of confidence for HAM parameters such as the HAM interval and term can be obtained. These measures of confidence may be geographically dependent, and can be mapped to present geographic information on the confidence level of any given analysis. Sensitivity data regarding a wide array of parameters used in a HAM run can also be obtained.

### Presentation and Preservation of the Information—Mapping

The method of the embodiment preferably includes a step of preservation and presentation of the data, in any or all of a number of ways. The first such way is via mapping.

Preferably, for a given geologic hazard, i.e., a given geologic area and a given hazard type and level (e.g., an MTC of a given magnitude, or a tsunami of a given height), a presentation routine calculates a finite plurality of probability layers. Each probability layer contains data, e.g., data representing a probability range of a hazard level at locations over the geographic area (or a subset thereof) (i.e., data representing the region of locations over which a particular probability level of the hazard reaching the hazard level exists). Using this type of probability space presentation, a wide variety of data is preferably made available, including all of the above-mentioned physical and probabilistic quantities.

As an example, one probability layer could represent the geographic region over which an MTC having a maximum sediment velocity of 10 m/s would occur with a probability of at least 2%, while a second probability layer could represent the geographic region over which an MTC having a maximum sediment velocity of 10 m/s would occur with a probability of at least 25%. As a second example, one probability layer could represent the geographic region over which a tsunami of at least 20 feet would occur with a probability of at least 2%, while a second probability layer could represent the geographic region over which a tsunami of at least 20 feet would occur with a probability of at least 90%.

In some cases, assessments are preferably only run over relevant subsets of the total geographic area. Such an assessment area will typically be the area for which there is a significant possibility of a hazard level occurring. Also, it can sometimes be the case that the regions of one layer significantly overlap the regions of other layers. This might more likely to happen for areas having rapidly varying parameters, or for small hazard level variations. Nevertheless, even when this is the case, the small differences between regions might be particularly relevant.

While a first map can preferably be generated at a first hazard level, other maps can be generated at other hazard levels, providing a working group of maps that together indicate probability sensitivity by location over a geographic area. For example, a first map could pertain to the geographic region over which an MTC has a maximum sediment velocity of 10 m/s, while a second map could pertain to the geographic region over which an MTC has a maximum sediment velocity of 20 m/s.

Because complex layering can sometimes unnecessarily complicate a hazard analysis, the number of different probability ranges used in each map is preferably limited. Nevertheless, the number of probability ranges (and related layers) may be determined on a case by case basis by considering the relevant levels of effect, e.g., the important differences in danger (i.e., hazard) level or damage (i.e., risk) level.

A variety of other types of information layers may preferably be used with the probability layers. For example, additional layers preferably provide local geographic information, or even real-time data on the actual state of hazard parameters. For example, at various geographic locations, layers may be used to indicate a higher likelihood of locating oil, or the existence of unstable geologic conditions such as present volcanic activity. This information, in combination with MTC probabilities could provide guidance as to locations with higher probabilities for finding oil and lower probabilities for having operations destroyed by an MTC.

The preparation and production of the above-identified maps relating probability layers, the production of useful sets including relevant combinations (as noted above) of these layers, and the use of such sets of maps for hazard assessment (including exploration planning, hazard planning, hazard response, hazard mitigation and risk assessment), are within the anticipated scope of the invention.

### Presentation and Preservation of the Information—GIS

Preferably, the data forming the various layers described above are compiled in respective layers of a geographical information system (“GIS”). As with the maps described above, the GIS provides an assessment tool for comparing relevant layer data and producing hazard assessment results. Using various hazard assessment results, exploration plans and emergency response plans may be prepared, and emergency crews can plan the timing and order of their efforts.

Therefore, the programming of layers representing the above-identified map layers relating to probability layers, the method of production of computer systems programmed with a GIS incorporating such layers, and the use of such a computer system for hazard assessment (including hazard planning, hazard response, hazard mitigation and risk assessment), is within the anticipated scope of the invention.

### Routines

In developing the probability layers described above, various combinations of the above-noted routines are particularly useful. Additionally, routines for automatically importing and updating such layers into a GIS are particularly useful. The preparation and production of the above-identified routines for probability layers, the production of useful sets of such routines, and the use of such routines for the development of hazard assessment layers are within the anticipated scope of the invention. Furthermore, the routines themselves are within the scope of the invention, as available on a computer readable medium. Likewise, a computer configured to run such routines is within the scope of the invention, as are transmissions from a computer that incorporate the routines or the results of running the routines.

While particular forms of the invention have been illustrated and described, it will be apparent that various modifications can be made without departing from the spirit and scope of the invention. Thus, although the invention has been described in detail with reference only to the preferred embodiments, those having ordinary skill in the art will appreciate that various modifications can be made without departing from the scope of the invention. Accordingly, the invention is not intended to be limited by the above discussion, and is defined with reference to the following claim. Nevertheless, it is to be understood that the invention is further understood to be various combinations of the above-described features.

What is to be claimed is:

1. A method of hazard assessment for a given geographic scenario, comprising:
establishing a Hazard Assessment Model (HAM) for the geographic scenario, including a plurality of geologic models that predict events for the geologic scenario;
establishing a set of the parameters necessary for using the plurality of geologic models to predict their respective events, wherein each parameter is defined by a combination of one or more of a group comprising established probabilities, established initial conditions, and established parameters defining change over time;
analyzing the HAM in time intervals over a time period, wherein at each time interval at least one geologic model of the plurality of geologic models is selected to establish an event state, wherein each geologic models of the plurality of geologic models is selected in more than one of the time intervals;
accumulating data on the established event states and their related parameters over the time period covered in the step of analyzing the HAM.

2. The method of claim 1, and further comprising conducting a parametric analysis of the accumulated data.

3. The method of claim 1, and further comprising generating map data comprising information defining a plurality of layers, wherein each layer pertains to a range of probabilities or specific physical results that a given event will occur.
